(19) United States
(12) Patent Application Publication
(10) Pub. No.: US 2009/0012222 A1
(43) Pub. Date: Jan. 8, 2009

(54) LOW INDIVIDUAL COLOUR THERMOPLASTIC MOLDING COMPOSITION

(75) Inventors: Wil Duijzings, Born (NL); Davy Roger Suwier, Tamaulipas (MX); Martin Weber, Maikammer (DE); Michel Pepers, Ludwigshafen (DE)

Correspondence Address: CONNOLLY BOVE LODGE & HUTZ LLP, 1875 EYE STREET, N.W., SUITE 1100, WASHINGTON, DC, 20006, US

(73) Assignee: BASF SE Patents, Trademarks and Licenses, Ludwigshafen (DE)

(21) Appl. No.: 12/162,231

(22) PCT Filed: Jan. 24, 2007
(86) PCT No.: PCT/EP2007/050683

§ 371 Date: Jul. 25, 2008

(30) Foreign Application Priority Data
Jan. 25, 2006 (EP) 06100856.1

(51) Int. Cl. C08K 3/38

(52) U.S. Cl. 524/405; 524/404

(57) ABSTRACT

A thermoplastic molding composition comprising A) 2.5 to 50 wt. % of a rubber modified styrenic resin; B) 50 to 97.5 wt. % of a polycarbonate resin; C) 0.001 to 1 wt. % of an inorganic boron compound; D) 0 to 25 wt. % of further polymer resins; and E) 0 to 45 wt. % additives, shows excellent thermal stability at high temperatures and impact resistance, and no thermal discolouration during processing.

The invention relates to a thermoplastic molding composition prepared from rubber modified styrenic resins and polycarbonate (PC) resins, a process for its production and its use for the production of moldings.

Mixtures of rubber modified styrenic resins and polycarbonate and their use as molding compositions are known. They generally contain an ABS (acrylonitrile butadiene styrene) or an ASA (acrylonitrile styrene acrylate) resin, which, in the case of an ABS resin, is composed of, for example, a copolymer of styrene and acrylonitrile and a graft copolymer of styrene and acrylonitrile onto a diene rubber, such as polybutadiene, and, for example, a polycarbonate based on bisphenol A. These molding compositions are characterized by good strength both at room temperature and at low temperatures, good processability and elevated heat resistance.

A disadvantage of such molding compositions is that in order to avoid deleterious effects on the polycarbonate and therefore an accompanying deterioration of properties, rubber modified styrenic resins which are free of basic components must be used in their production.

Previously, due to this requirement, a specially produced or worked up rubber modified styrenic resin which is free of basic constituents, always had to be prepared for use in rubber modified styrenic resins/polycarbonate mixtures. Rubber modified styrenic resins, which are not intended from the outset for blending with polycarbonates, often contain basic additives (for example as lubricants or mold release agents) or contain metal salts of fatty acids like magnesiumstearate resulting from the work up procedure. This also applies to rubber modified styrenic resins which are blended with polymers other than polycarbonate. Such rubber modified styrenic resins containing basic components cannot, therefore, be used for the production of rubber modified styrenic resins/polycarbonate mixtures.

In US U.S. Pat. No. 5,420,181 it is disclosed that by using special polymer resins bearing carboxyl groups as blend components, mixtures of aromatic polycarbonate resins and ABS resins containing basically acting components may be produced, which mixtures give moldings with good properties.

There are, however, still disadvantages, because these additives do not prevent thermal discoloration and some mechanical properties (elongation at break and notched impact strength) tend to decrease.

In JP58067745 a composition with increased heat and shock resistance is described, which is prepared by adding an organic carboxylic acid stabilizer and an organophosphate stabilizer to a PC/ABS resin. However, with these additives, thermal discoloration during processing is not prevented.

Polycarbonate-rubber modified styrenic resin blends are a well known for applications in the automotive sector and in the electrical engineering/electronics sector. The favorable combination of properties of good heat resistance and good mechanical values, for example, in terms of the notched impact strength or stress cracking behavior, has always proved to be advantageous. If, nevertheless, the notched impact strength or the stress cracking resistance should be insufficient for certain parts, the conventional procedure is to increase the rubber content. This measure is, however, always associated with a marked reduction in the heat resistance.

In U.S. Pat. No. 6,326,423 is disclosed that this problem may be solved using metal salts of organic monophosphates or diphosphoric acids. However these compounds do not pre-vent discoloration during processing.

JP2001139765 describes a composition of a polycarbonate resin and an ABS resin with good thermal stability and impact resistance that shows no thermal discoloration during processing. This composition of the polycarbonate resin and the ABS resin is obtained by mixing polycarbonate resin and ABS-based resin, and the ABS-based resin is obtained by using a partially hydrogenated conjugate dienic rubber. However due to the hydrogenation the Tg of the dienic rubber will rise and as a consequence the low temperature impact properties will decrease.

In U.S. Pat. No. 5,910,538 a thermoplastic molding composition containing a blend of a polycarbonate, vinyl copolymer, such as SAN, and a graft polymer, such as ABS is disclosed, which includes a compatibilizing agent which comprises a polymeric resin which contains secondary amine reactive groups in its structure.

A disadvantage, however, is the crosslinking and discoloration at high temperatures Boric compounds like boric acid, ammonium borate, ammonium boron oxide, ortho- and metaboric acid are well known. They are often used to prevent discoloration of polymer molding compositions.

In JP11043613 a method is described to prevent thermal discoloration during molding by adding a specified amount of a boric acid to an antibacterial resin comprising a synthetic resin and a silver-based antibacterial agent. The synthetic resin used is exemplified by a phenolic resin, a polyurethane, a vinyl chloride resin, a polypropylene, a polystyrene, a polyethylene terephthalate, nylon 6, a polycarbonate or a polyphenylene sulfide. The boric acid used is orthoboric acid or metaboric acid.

In JP10245495 a method is described to obtain an antibacterial resin composition by compounding a resin with a boric acid ester. Preferably, the boric component is orthoboric acid (H₃BO₃), etc., or a mono, di or triester of boric acid and an alcohol and its amount is about 0.005-10 wt. % based on 100 wt. % of the resin.

In JP7292213 a method is described to obtain a resin composition which has a high impact resistance and does not discolor when extruded by adding boric acid or boric ester to a three-component blend comprising an ABS resin, a polyester resin, and a polycarbonate resin. This thermoplastic resin composition is prepared by adding 0.002-2.wt. % boric acid or boric ester to 100.wt. % three-component blend comprising 90-60 wt. % ABS resin and 10-40 wt. % mixture consisting of a thermoplastic polyester resin and an arom. polycarbonate resin in a wt. ratio of (5:95)-(95:5). However, these blends contain less then 50% aromatic polycarbonate resin and the ABS resin is free of basic additives.

U.S. Pat. No. 4,415,692 describes the thermal stabilization of mixtures of aromatic polycarbonates and ABS polymers using 0.01 to 3 wt. % of esters of boric acid, in particular with ortho and/or para-alkyl substituted phenols or the corresponding bis-phenols.

However, these esters are not commercially available and although they improve the thermal characteristics and the surface of the products they not prevent the thermal discoloration during processing.

The purpose of the invention is to obtain a composition of a polycarbonate resin and a rubber modified styrenic resin containing basic additives, excellent in thermal stability at high temperature, impact resistance and prevented from thermal discoloration during processing.

It has now been found that even low amounts of an inorganic boric compound not only prevent discoloration of rubber modified styrenic resin/PC blends which contain a high amount of the base sensitive PC, but also improve the mechanical properties (notched impact) and prevent deleterious effects on the polycarbonate and, therefore, an accompanying deterioration of properties, if rubber modified styrenic resins containing basically acting constituents are used.

Accordingly, in one aspect of the invention there is provided a thermoplastic molding composition (F) comprising

A) 2.5 to 50 wt. % of a rubber modified styrenic resin;
B) 50 to 97.5 wt. % of a polycarbonate resin;
C) 0.001 to 1 wt. % of an inorganic boron compound;
D) 0 to 25 wt. % of further polymer resins; and
E) 0 to 45 wt. % additives.

In a further aspect of the invention there is provided a process for producing a thermoplastic molding composition (F) comprising the step of blending components (A) to (E) at elevated temperatures.

In a further aspect of the invention there is provided the use of a thermoplastic molding composition (F) for producing a molding.

In yet a further aspect of the invention there is provided a molding, produced from a thermoplastic molding composition (F).

The thermoplastic molding composition according to the invention shows excellent thermal stability at high temperatures, impact resistance and no thermal discolouration during processing.

The thermoplastic molding compositions preferably contain from 2.5 to 50 parts by weight, particularly preferably from 10 to 50 parts by weight, in particular from 25 to 45 parts by weight, of component (A), preferably from 50 to 97.5 parts by weight, particularly preferably from 50 to 90 parts by weight, in particular from 55 to 75 parts by weight, of component B and preferably from 0.001 to 1 parts by weight, particularly preferably from 0.0025 to 0.5 parts by weight, in particular from 0.005 to 0.1 parts by weight, of component C.

Preferably the thermoplastic molding composition comprises from 0.001 to 10, more preferred from 0.01 to 7.5, in particular 0.03 to 5 wt. % of a basic component. The basic component may either be a basic additive E or may result from the synthesis of the composition.

The rubber modified styrenic resin is preferably an ABS resin or an ASA resin. The rubber modified styrenic resins (component A) contain 5 to 100 wt. %, preferably 10 to 80 wt. % and more preferred 20 to 65 wt. %, of a graft polymer (A1) and 95 to 0% wt. %, preferably 90 to 20 wt. % and more preferred 80 to 35 wt. %, of a thermoplastic copolymer resin (A2).

The graft base (a1) is present in a proportion of from 40 to 90 wt. %, preferably from 45 to 85 wt. %, and particularly preferably from 50 to 80 wt. %, based on component (A1).

The graft base (a1) is obtained by polymerizing, based on (a1),
a11) from 70 to 100 wt. %, preferably from 75 to 100 wt. %, and particularly preferably from 80 to 100 wt. %, of one conjugated diene, or of at least one C₁₋₈-alkyl acrylate, or of mixtures of these,
a12) from 0 to 30 wt. %, preferably from 0 to 25 wt. %, and particularly preferably from 0 to 20 wt. %, of at least one other monoethylenically unsaturated monomer,
a13) from 0 to 10 wt. % of at least one polyfunctional, cross linking monomer.

Examples of conjugated dienes (a11) are butadiene, isoprene, chloroprene and mixtures of these. Preference is given to the use of butadiene or isoprene or mixtures of these, and butadiene is particularly preferred.

Examples of C₁₋₈-alkyl acrylate (a11) are, n-butyl acrylate and/or ethylhexyl acrylate, n-butylacrylate is particularly preferred.

Constituent (a1) of the molding compositions may also contain, with corresponding reduction in the monomers (a11), other monomers (a12) which vary the mechanical and thermal properties of the core within a certain range. Examples of such mono-ethylenically unsaturated comonomers are:

vinylaromatic monomers, such as styrene and styrene derivatives of the formula (I),

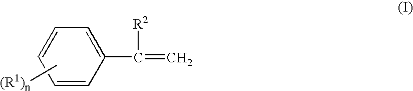

where R¹ and R² are hydrogen or C₁-C₈-alkyl and n is 0, 1, 2 or 3;
methacrylonitrile, acrylonitrile;
acrylic acid, methacrylic acid, and also dicarboxylic acids, such as maleic acid and fumaric acid and their anhydrides, such as maleic anhydride;
nitrogen-functional monomers, such as dimethylaminoethyl acrylate, diethylaminoethyl acrylate, vinylimidazole, vinylpyrrolidone, vinylcaprolactam, vinylcarbazole, vinylaniline, acrylamide;
C₁-C₁₀-alkylacrylates, such as methyl acrylate, ethyl acrylate, n-propyl acrylate, isopropyl acrylat, n-butyl acrylate, isobutyl acrylate, sec-butyl acrylate, tert-butyl acrylate, ethylhexyl acrylate, and the corresponding C₁-C₁₀-alkyl methacrylates, and hydroxyethyl acrylate;
aromatic and araliphatic (meth)acrylates, such as phenyl acrylate, phenyl methacrylate, benzyl acrylate, benzyl methacrylate, 2-phenylethyl acrylate, 2-phenylethyl methacrylate, 2-phenoxyethyl acrylate and 2-phenoxyethyl methacrylate;
N-substituted maleimides, such as N-methyl-, N-phenyl- and N-cyclohexylmaleimide;
unsaturated ethers, such as vinyl methyl ether
and mixtures of these monomers.

Preferred monomers (a12) are styrene, α-methylstyrene, n-butyl acrylate or mixtures of these, styrene and n-butyl acrylate or mixtures of these being particularly preferred and styrene being very particularly preferred. Styrene or n-butyl acrylate or mixtures of these are preferably used in amounts of, in total, up to 20 wt. %, based on (a1).

In principle, any crosslinking monomer can be used as component (a13). Examples of polyfunctional crosslinking monomers are divinylbenzene, diallyl maleate, diallyl fumarate, diallyl phthalate, diethyl phthalate, triallyl cyanurate, triallyl isocyanurate, tricyclodecenyl acrylate, dihydrodicyclopentadienyl acrylate, triallyl phosphate, allyl acrylate, and allyl methacrylate.

Dicyclopentadienyl acrylate (DCPA) has proven to be a particularly useful crosslinking monomer.

Further suitable rubbers are, for example, the so-called EPDM rubbers (polymers of ethylene, propylene and an unconjugated diene such as dicyclopentadiene), EPM rubbers (ethylene/propylene rubbers) and silicone rubbers, which may also optionally have a core/shell structure.

In a particular embodiment, use is made of a graft base made from, based on (a1),
a11) from 70 to 99.9, preferably from 90 to 99 wt. %, of butadiene, and
a12) from 0.1 to 30, preferably from 1 to 10 wt. %, of styrene.

The graft (a2) is present in a proportion of from 10 to 60 wt. %, preferably from 15 to 55 wt. %, and particularly preferably from 20 to 50 wt. %, based on component (A1).

The graft (a2) is obtained by polymerizing, based on (a2),
a21) from 65 to 95 wt. %, preferably from 70 to 90 wt. %, and particularly preferably from 75 to 85 wt. %, of at least one vinylaromatic monomer,
a22) from 5 to 35 wt. %, preferably from 10 to 30 wt. %, and particularly preferably from 15 to 25 wt. % of acrylonitrile,
a23) from 0 to 30 wt. %, preferably from 0 to 20 wt. %, and particularly preferably from 0 to 15 wt. %, of at least one further monoethylenically unsaturated monomer, and
a24) from 0 to 10%, preferably from 0 to 5%, more preferred from 0 to 2 wt. % of at least one polyfunctional, cross linking monomer.

Examples of vinylaromatic monomers can be styrene and styrene derivatives of the formula (I)

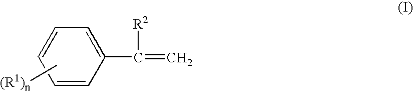

where R¹ and R² are hydrogen or C₁-C₈-alkyl and n is 0, 1, 2 or 3. Preference is given to the use of styrene.

Examples of other monomers (a23) are the monomers given above for component (a12). Methyl methacrylate and acrylates, such as n-butyl acrylate, are particularly suitable. Methyl methacrylate MMA is very particularly suitable as monomer (a23), an amount of up to 20 wt. % of MMA, based on (a2), being preferred.

In principle, any cross linking monomer can be used as component (a24). Examples of polyfunctional cross linking monomers are divinylbenzene, diallyl maleate, diallyl fumarate, diallyl phthalate, diethyl phthalate, triallyl cyanurate, triallyl isocyanurate, tricyclodecenyl acrylate, dihydrodicyclopentadienyl acrylate, triallyl phosphate, allyl acrylate, and allyl methacrylate. Dicyclopentadienyl acrylate (DCPA) has proven to be a particularly useful cross linking monomer.

The graft polymers are prepared by emulsion polymerization, usually at from 20 to 100° C., preferably from 30 to 80° C. Additional use is usually made of customary emulsifiers, for example alkali metal salts of alkyl- or alkylarylsulfonic acids, alkyl sulfates, fatty alcohol sulfonates, salts of higher fatty acids having from 10 to 30 carbon atoms, sulfosuccinates, ether sulfonates or resin soaps. It is preferable to use the alkali metal salts, in particular the Na and K salts, of alkylsulfonates or fatty acids having from 10 to 18 carbon atoms.

The emulsifiers are generally used in amounts of from 0.5 to 5 wt. %, in particular from 0.5 to 3 wt. %, based on the monomers used in preparing the graft base (a1).

In preparing the dispersion, it is preferable to use sufficient water to give the finished dispersion a solids content of from 20 to 50 wt. %. A water/monomer ratio of from 2:1 to 0.7:1 is usually used.

Polymerization is generally carried out in the presence of a radical generating substance.

Suitable free-radical generators for initiating the polymerization are those which decompose at the selected reaction temperature, i.e. both those which decompose by themselves and those which do so in the presence of a redox system. Examples of preferred polymerization initiators are free-radical generators such as peroxides, preferably peroxosulfates (such as sodium or potassium peroxosulfate) and azo compounds, such as azodiisobutyronitrile. It is also possible, however, to use redox systems, especially those based on hydroperoxides, such as cumene hydroperoxide.

The polymerization initiators are generally used in amounts of from 0.1 to 1 wt. %, based on the graft base monomers (a11) and (a12).

In a preferred embodiment the polymerization initiators are inorganic peroxides, preferably peroxidisulfates (in particular sodium, potassium or ammonium peroxidisulfate).

In this preferred embodiment—to reduce the formation of odor generating substances—the use of azo compounds, such as azodiisobutyronitrile, or redox systems based on organic peroxides and/or hydroperoxides, such as cumene hydroperoxides, is excluded.

The free-radical generators and also the emulsifiers are added to the reaction mixture, for example, batchwise as a total amount at the beginning of the reaction or in stages, divided into a number of portions, at the beginning and at one or more later times, or continuously over a defined period. Continuous addition may also follow a gradient, which may, for example, rise or fall and be linear or exponential or even a step function.

It is also possible to include in the reaction molecular weight regulators, such as ethyl-hexyl thioglycolate, n-dodecyl or t-dodecyl mercaptane or other mercaptans, terpinols and dimeric α-methylstyrene or other compounds suitable for regulating molecular weight. The molecular weight regulators may be added to the reaction mixture batch-wise or continuously, as described above for the free-radical generators and emulsifiers.

In a preferred embodiment use is made of one or more molecular weight regulators containing a mercapto group, such as alkyl mercaptanes, preferably (C₆-C₂₀)alkyl mercaptanes, such as n-dodecyl mercaptane and t-dodecyl mercaptane, or thioglycolates, such as esters or salts of thioglycolic acid, e.g. 2-ethyl-hexyl thioglycolate.

The use of n- or t-dodecyl mercaptane is particularly preferred.

In the preferred embodiment the amount of the molecular weight regulators is >0.5 and <1.2, more preferred >0.6 and <1.0 and most preferred >0.7 and <0.9 wt. % based on monomers (a1).

To maintain a constant pH, preferably of from 7 to 10, it is possible for the reaction to include buffer substances such as Na₂HPO₄/NaH₂PO₄, sodium hydrogen carbonate or buffers based on citric acid/citrate. Regulators and buffer substances are used in the customary amounts, and further details on this point are, therefore, well known to those skilled in the art.

In a particularly preferred embodiment, a reductant is added during the grafting of the graft base a1) with the monomers (a21) to (a23).

In a particular embodiment, it is also possible to prepare the graft base by polymerizing the monomers (a1) in the presence of a finely divided latex (the seed latex method of polymerization). This latex is the initial charge and may be made from monomers which form elastomeric polymers or else from other monomers mentioned above. Suitable seed latices are made from, for example, polybutadiene or polystyrene.

In another preferred embodiment, the graft base (a1) may be prepared by the feed method. In this process, the polymerization is initiated using a certain proportion of the monomers (a1), and the remainder of the monomers (a1) (the feed portion) is added as feed during the polymerization. The feed parameters (gradient shape, amount, duration, etc.) depend on the other polymerization conditions. The principles of the descriptions given in connection with the method of addition of the free-radical initiator and/or emulsifier are once again relevant here. In the feed process, the proportion of the monomers (a1) in the initial charge is preferably from 5 to 50 wt. %, particularly preferably from 8 to 40 wt. %, based on a1). The feed portion of (a1) is preferably fed in within a period of from 1 to 18 hours, in particular from 2 to 16 hours, very particularly from 4 to 12 hours.

Graft polymers having a number of “soft” and “hard” shells, e.g. of the structure (a1)-(a2)-(a1)-(a2) or (a2)-(a1)-(a2), are also suitable, especially where the particles are of relatively large size.

The precise polymerization conditions, in particular the type, amount and method of addition of the emulsifier and of the other polymerization auxiliaries are preferably selected so that the resultant latex of the graft polymer A has a mean particle size, defined by the d₅₀ of the particle size distribution, of from 80 to 800, preferably from 80 to 600 and particularly preferably from 85 to 400.

The reaction conditions are preferably balanced so that the polymer particles have a bimodal particle size distribution, i.e. a particle size distribution having two maxima whose distinctness may vary. The first maximum is more distinct (peak comparatively narrow) than the second and is generally at from 25 to 200 nm, preferably from 60 to 170 nm and particularly preferably from 70 to 150 nm. The second maximum is broader in comparison and is generally at from 150 to 800 nm, preferably from 180 to 700, particularly preferably from 200 to 600 nm. The second maximum here (from 150 to 800 nm) is at larger particle sizes than the first maximum (from 25 to 200 nm).

The bimodal particle size distribution is preferably achieved by (partial) agglomeration of the polymer particles. This can be achieved, for example, by the following procedure: the monomers a1), which form the core, are polymerized to a conversion of usually at least 90%, preferably greater than 95%, based on the monomers used. This conversion is generally achieved in from 4 to 20 hours. The resultant rubber latex has a mean particle size d₅₀ of not more than 200 nm and a narrow particle size distribution (virtually monodisperse system).

In the second step, the rubber latex is agglomerated. This is generally done by adding a dispersion of an acrylate polymer. Preference is given to the use of dispersions of copolymers of C₁-C₄-alkyl acrylates, preferably of ethyl acrylate, with from 0.1 to 10 wt. % of monomers which form polar polymers, examples being acrylic acid, methacrylic acid, acrylamide, methacrylamide, N-methylol methacrylamide and N-vinylpyrrolidone. Particular preference is given to a copolymer of 96% of ethyl acrylate and 4% of methacrylamide. The agglomerating dispersion may, if desired, also contain more than one of the acrylate polymers mentioned.

In general, the concentration of the acrylate polymers in the dispersion used for agglomeration should be from 3 to 40 wt. %. For the agglomeration, from 0.2 to 20 parts by weight, preferably from 1 to 5 parts by weight, of the agglomerating dispersion are used for each 100 parts of the rubber latex, the calculation in each case being based on solids. The agglomeration is carried out by adding the agglomerating dispersion to the rubber. The addition rate is usually not critical, and the addition usually takes from 1 to 30 minutes at from 20 to 90° C., preferably from 30 to 75° C.

Besides an acrylate polymer dispersion, use may also be made of other agglomerating agents, such as acetic anhydride, for agglomerating the rubber latex. Agglomeration by pressure or freezing is also possible. The methods mentioned are known to the person skilled in the art.

Under the conditions mentioned, the rubber latex is only partially agglomerated, giving a bimodal distribution. More than 50%, preferably from 75 to 95%, of the particles (distribution by number) are generally in the non-agglomerated state after the agglomeration. The resultant partially agglomerated rubber latex is relatively stable, and it is therefore easy to store and transport it without coagulation occurring.

To achieve a bimodal particle size distribution of the graft polymer (A1), it is also possible to prepare, separately from one another in the usual manner, two different graft polymers (A1′) and (A1″) differing in their mean particle size, and to mix the graft polymers (A1′) and (A1″) in the desired mixing ratio.

The polymerization of the graft base (a1) is usually carried out with reaction conditions selected to give a graft base having a particular crosslinked nature. Examples of parameters which are important for this are the reaction temperature and duration, the ratio of monomers, regulator, free-radical initiator and, for example in the feed process, the feed rate and the amount and timing of addition of regulator and initiator.

One method for describing the crosslinked nature of crosslinked polymer particles is measurement of the swelling index QI, which is a measure of the solvent-swellability of a polymer having some degree of crosslinking. Examples of customary swelling agents are methyl ethyl ketone and toluene. The QI of the novel molding compositions is usually in the range of from 10 to 60, preferably from 15 to 55 and particularly preferably from 20 to 50.

Gel content is another criterion for describing the graft base and its extent of crosslinking, and is the proportion of material which is crosslinked and therefore insoluble in a particular solvent. It is useful to determine the gel content in the solvent also used for determining the swelling index. Gel contents of the graft bases a1) according to the invention are usually in the range from 50 to 90%, preferably from 55 to 85% and particularly preferably from 60 to 80%.

The following method may, for example, be used to determine the swelling index: about 0.2 g of the solid from a graft base dispersion converted to a film by evaporating the water is swollen in a sufficient quantity (e.g. 50 g) of toluene. After, for example, 24 h, the toluene is removed with suction and the specimen is weighed. The weighing is repeated after the specimen has been dried in vacuum. The swelling index is the ratio of the specimen weight after the swelling procedure to the dry specimen weight after the second drying. The gel content is calculated correspondingly from the ratio of the dry weight after the swelling step to the weight of the specimen before the swelling step (×100%)

The graft (a2) may be prepared under the same conditions as those used for preparation of the graft base (a1) and may be prepared in one or more process steps. In two-stage grafting, for example, it is possible to polymerize styrene and/or α-methylstyrene alone, and then styrene and acrylonitrile, in two sequential steps. This two-step grafting (firstly styrene, then styrene/acrylonitrile) is a preferred embodiment. Further details concerning the preparation of the graft polymers (A1) are given in DE-OS 12 60 135 and 31 49 358.

It is advantageous in turn to carry out the graft polymerization onto the graft base (a1) in aqueous emulsion. It may be undertaken in the same system used for polymerizing the graft base, and further emulsifier and initiator may be added. These need not be identical with the emulsifiers and/or initiators used for preparing the graft base (a1). For example, it may be expedient to use a persulfate as initiator for preparing the graft base (a1) but a redox initiator system for polymerizing the graft shell (a2). Otherwise, that which was said for the preparation of the graft base (a1) is applicable to the selection of emulsifier, initiator and polymerization auxiliaries. The monomer mixture to be grafted on may be added to the reaction mixture all at once, in portions in more than one step- or, preferably, continuously during the polymerization.

In a preferred embodiment initiators which are preferred in the preparation of (a1) are used and no molecular weight regulators are used in the preparation of (a2).

If non-grafted polymers are produced from the monomers (a2) during the grafting of the graft base (a1), the amounts, which are generally less than 10 wt. % of (a2), are attributed to the weight of component (A1).

The thermoplastic copolymers (A2) may be built up from the graft monomers or similar monomers, in particular from at least one monomer from the range styrene, α-methylstyrene, halogen styrene, acrylonitrile, methacrylonitrile, methyl methacrylate, maleic anhydride, vinyl acetate and N-substituted maleimide. These thermoplastic co-polymers are preferably copolymers of 95 to 50 wt. % of styrene, α-methylstyrene, methyl methacrylate or mixtures thereof with 5 to 50 wt. % of acrylonitrile, methacrylonitrile, methyl methacrylate, maleic anhydride or mixtures thereof.

Such copolymers also occur as by-products during graft copolymerization. It is customary to incorporate separately produced copolymers as well as the copolymers contained in the graft polymer. These separately produced copolymers are not necessarily chemically identical to the ungrafted resin constituents present in the graft polymers.

Suitable separately produced copolymers are resinous, thermoplastic and contain no rubber; they are in particular copolymers of styrene and/or α-methylstyrene with acrylonitrile, optionally mixed with methyl methacrylate.

Particularly preferred copolymers consist of 18 to 40 wt. % of acrylonitrile and 82 to 60 wt. % of styrene or α-methylstyrene. The polymers (A2), which due to their main components styrene and acrylonitrile are generally also referred to as SAN polymers, are known and in some cases also commercially available.

Component (A2) has a viscosity number VN (determined according to DIN 53 726 at 25° C. on a 0.5% strength by weight solution of component (A) in dimethylformamide) of from 50 to 120 ml/g, preferably from 52 to 110 ml/g and particularly preferably from 55 to 105 ml/g. The copolymers generally have average molecular weights (Mw) of 15,000 to 250,000, preferably 50,000 to 200,000.

It is obtained in a known manner by bulk, solution, suspension or precipitation polymerization, bulk and solution polymerization being preferred. Details of these processes are described, for example, in Kunststoffhandbuch, ed. R. Vieweg and G. Daumiller, Vol. V “Polystyrol”, Carl-Hanser-Verlag Munich, 1969, p. 118 ff.

Details concerning the preparation of the rubber modified styrenic resin are as follows:

The graft polymers having bimodal particle size distribution are preferably prepared by emulsion polymerization, as described above for component (A1). As described above, suitable measures are taken in order to establish the bimodal particle size distribution, preference being given to (partially) agglomerating the polymer particles, as mentioned, by adding a polyacrylate dispersion which has agglomerating effect. Instead of this, or combined with the (partial) agglomeration, it is possible to use other suitable measures familiar to the person skilled in the art to establish the bimodal particle size distribution.

The dispersion of component (A1) is worked up in a manner known per se. Component (A1) is firstly precipitated from the dispersion, for example by adding salt solutions (such as calcium chloride, magnesium sulphate or alum) which can bring about precipitation, or else by freezing (freeze coagulation). The first method is preferred. The aqueous phase may be removed in a usual manner, for example screening, filtering, decanting or centrifuging. This preliminary removal of the dispersion water gives polymers (A1) which are moist with water and have a residual water content of up to 60 wt. %, based on (A1), where the residual water may, for example, either adhere externally to the polymer or else be enclosed within it.

After this, the polymer may, if required, be dried in a known manner, for example by hot air or using a pneumatic dryer. It is likewise possible to work up the dispersion by spray drying.

If one or more components are incorporated in the form of an aqueous dispersion or of an aqueous or non-aqueous solution, the water or the solvent is removed from the mixing apparatus, preferably an extruder, via a devolatilizing unit.

Examples of mixing apparatuses are discontinuously operating heated internal mixers with or without rams, continuously operating kneaders, such as continuous internal mixers, screw compounders having axially oscillating screws, Banbury mixers, and also extruders, roll mills, mixing rolls where the rolls are heated and calenders.

Preference is given to using an extruder as mixing apparatus. Single- or twin-screw extruders, for example, are particularly suitable for extruding the melt. A twin-screw extruder is preferred.

Mixing of polymer (A1) with (A2) and, optionally, (C), (D) and (E) to produce a rubber modified styrenic resin may be carried out by any known method and in any desired manner. However, blending of the components is preferably carried out by co extruding, kneading or roll-milling the components at temperatures of preferably from 180 to 400° C.

If basic additives are contained in the rubber modified styrenic resin component (A), those are usually compounds, which were formed during the work up of the graft dispersion. ABS or ASA resins prepared by emulsion polymerization often contain, due to the work up procedure, metal salts of fatty and/or rosin acids, like magnesiumstearate. The proportion of basically acting additive, related to the ABS or ASA resin, is generally from about 0.01 to 5 wt. %, it being possible for the proportion to vary in an upward or downward direction. The proportion of basically acting additive is preferably from about 0.05 to 3 wt. %, related to ABS or ASA.

Basic additives (E) can also be added to component (A) or to the final composition (F) to improve its properties, for example lubricants, mold release agents, antistatic agents, stabilizers and light stabilizers.

Examples of basic components are carboxylic acid (di)amides, for example stearic acid amide or ethylenediamine bis-stearyl amide, metal salts of long-chain carboxylic acids, for example calcium zinc and/or magnesium stearate, ethoxylated fatty amines, fatty acid ethanolamides, sterically hindered phenols, for example 2,4-bis(n-octylthio)-6-(4-hydroxy-3,5-tert.-butylanilino)-1,3,5-triazine, sterically hindered amines, for example sebacic acid bis-2,2,4,4-tetramethyl-4-piperidyl ester, benzotriazole derivatives, for example 2-(2′-hydroxy-5′-methylphenyl)-benzotriazole and butylated condensation products of para cresol and dicyclopentadiene (Wingstay L., Goodyear).

The polycarbonate resin (component B) of the invention is either an aromatic polycarbonate or an aliphatic polycarbonate.

In one embodiment component (B) is an aromatic polycarbonate.

Aromatic polycarbonate resins may be both homopolycarbonates and copolycarbonates prepared from diphenols of the formulae (II) and (III),

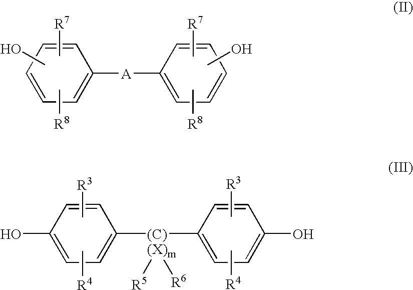

in which
A is a single bond, C₁-C₅ alkene, C₂-C₅ alkylidene, C₅-C₆ cycloalkylidene, —O—, —S—, or —SO₂—,
R⁷ and R⁸ mutually independently are hydrogen, methyl or halogen, preferably hydrogen, methyl, chlorine or bromine,
R³ and R⁴ mutually independently are hydrogen, halogen, preferably chlorine or bromine, C₁-C₈ alkyl, preferably methyl, ethyl, C₅-C₆ cycloalkyl, preferably cyclohexyl, C₆-C₁₀ aryl, preferably phenyl, or C₇-C₁₂ aralkyl, preferably phenyl-C₁-C₄-alkyl, in particular benzyl,
m is an integer from 4 to 7, preferably 4 or 5,
R⁵ and R⁶ are individually selectable for each X and are mutually independently hydrogen or C₁-C₆ alkyl, preferably methyl or ethyl, and
X is carbon.

The polycarbonates (B) may be both linear and branched, they may contain aromatically bonded halogen, preferably bromine and/or chlorine, they may also, however, be free of aromatically bonded halogen, thus free of halogen.

The polycarbonates (B) may be used both individually and blended.

The diphenols of the formulae (II) and (III) are either known in the literature or can be produced according to processes known in the literature (see for example EP-A-0 359 953).

Production of suitable polycarbonates (B) is known in the literature, for example such polycarbonates can be produced by the method of an ester exchange reaction between an aromatic dihydroxy compound and a carbonic acid diester. A melt condensation polymerization can also be performed in the presence of one or more catalysts (see for example U.S. Pat. No. 6,346,597, U.S. Pat. No. 5,606,008, U.S. Pat. No. 5,151,491).

The preparation of aromatic polycarbonates can also be performed via oligocarbonate intermediates by a minimum two step melt esterification process, from diphenols and carboxylic acid diaryl esters, in the presence of catalysts, where the oligocarbonate preparation step is carried out in at least one continuously working tubular reactor (see for example EP-A 0 735 073).

Production of the suitable polycarbonates according to component B may also, for example, proceed with phosgene in accordance with a phase interface process or with phosgene in accordance with the homogeneous phase process (the so-called pyridine process), wherein the particular molecular weight to be achieved is adjusted in a known manner with an appropriate quantity of known chain terminators.

Suitable chain terminators are, for example, phenol or p-tert.-butylphenol, but also long-chain alkyl phenols such as 4-(1,3-tetramethyl-butyl)phenol according to DE-A 2 842 005 or monoalkyl phenols or dialkyl phenols with a total of 8 to 20 carbon atoms in the alkyl substituents according to DE-A 3 506 472, such as, for example, p-nonylphenol, 2,5-di-tert.-butylphenol, p-tert.-octylphenol, p-dodecylphenol, 2-(3,5-dimethylheptyl)phenol and 4-(3,5-dimethylheptyl)phenol. The quantity of chain terminators to be used is generally between 0.5 and 10 mol %, related to the total of the particular diphenols (II) and (III) used.

The melt method offers the advantage of allowing cheaper manufacturing of polycarbonate than the interfacial method. Moreover, the melt method is also preferred from the standpoint of environmental hygiene, as it does not use toxic substances such as phosgene.

Suitable polycarbonates (B) may be branched in a known manner, namely, by way of example, by the incorporation of 0.05 to 2.0 mol % related to the total of the diphenols used, of trifunctional or greater than trifunctional compounds, for example such compounds with three or more than three phenolic OH groups.

These compounds have average weight average molecular weights (Mw, measured, for example, by ultracentrifuging or light-scattering measurement) of 10,000 to 200,000, preferably from 20,000 to 80,000.

Suitable diphenols of the formulae (II) and (III) are, for example, hydroquinone, resorcinol, 4,4′-dihydroxydiphenyl, 2,2-bis(4-hydroxyphenyl)propane, 2,4-bis(4-hydroxyphenyl)-2-methylbutane, 2,2-bis(4-hydroxy-3,5-dimethylphenyl)propane, 2,2-bis(4-hydroxy-3,5-dichlorophenyl)propane, 2,2-bis(4-hydroxy-3,5-dibromophenyl)propane, 1,1-bis(4-hydroxyphenyl)cyclohexane, 1,1-bis(4-hydroxyphenyl)-3,3,5-trimethylcyclohexane, 1,1-bis(4-hydroxyphenyl)-3,3-dimethylcyclohexane, 1,1-bis(4-hydroxyphenyl)-3,3,5,5-tetramethylcyclohexane and 1,1-bis(4-hydroxyphenyl)-2,4,4-trimethylcyclopentane.

Preferred diphenols of the formula (I) are 2,2-bis(4-hydroxyphenyl)propane and 1,1-bis(4-hydroxyphenyl)cyclohexane.

The preferred phenol of the formula (II) is 1,1-bis(4-hydroxyphenyl)-3,3,5-trimethylcyclohexane. Mixtures of diphenols may also be used.

In another embodiment component (B) is an aliphatic polycarbonate.

Preferably, component (B) is an aliphatic polycarbonate having a weight averaged molecular weight/M_{w} of from 20,000 to 500,000, preferably 25,000 to 300,000 and particularly preferably 30,000 to 200,000 and comprising repeating units of the formula (IV),

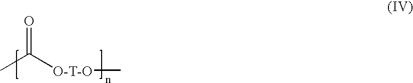

wherein
n is a number between 1 and 100, preferably 1 to 80 and particularly preferably 1 to 45, and
T denotes a branched or linear, saturated or unsaturated alkyl or cycloalkyl radical with 2 to 40 carbon atoms, preferably saturated linear alkyl diols with 3 to 15 carbon atoms, particularly preferably with 3 to 10 carbon atoms, most particularly preferably with 6 to 10 carbon atoms and especially with 7 to 10 carbon atoms, as well as a radical (V),

Al—O—Ar—O-A1 (V)

wherein A1 denotes branched or linear, saturated or unsaturated alkyl or cycloalkyl radicals with 2 to 40 carbon atoms and —O—Ar—O denotes an aromatic radical with 12 to 24 carbon atoms derived from a bisphenol, preferably bisphenol A, bisphenol TMC or bisphenol M.

T may also vary within the polymer molecule.

These polycarbonates may be branched in a controlled way by using small amounts of branching agents. Examples of suitable branching agents are:

phloroglucinol, 4,6-dimethyl-2,4,6-tri-(4-hydroxyphenyl-)heptane, 1,3,5-tri-(4-hydroxyphenyl)benzene, 1,1,1-tri-(4-hydroxyphenyl)ethane, tri-(4-hydroxyphenyl)phenylmethane, 2,2-bis-[4,4-bis-(4-hydroxyphenyl)cyclohexyl]propane, 2,4-bis-(4-hydroxyphenylisopropyl)phenol, 2,6-bis-(2-hydroxy-5′-methylbenzyl)-4-methylphenol, 2-(4-hydroxyphenyl)-2-(2,4-dihydroxyphenyl)propane, hexa-(4-(4-hydroxyphenylisopropyl)phenyl)ortho-terephthalic acid ester, tetra-(4-hydroxyphenyl)methane, tetra-(4-(4-hydroxyphenylisopropyl)phenoxy)methane, isatin biscresol, pentaerythritol, 2,4-dihydroxybenzoic acid, trimesic acid, cyanuric acid, 1,4-bis-(4′,4″-dihydroxytriphenyl)methyl-)benzene and α,α′α″-tris-(4-hydroxyphenyl)-1,3,4-triiso-propenylbenzene, 1,1,1-tri-(4-hydroxyphenyl)ethane and isatin biscresol are particularly preferred.

Aliphatic polycarbonates (B) may contain chain terminators. The corresponding chain terminators are known inter alia from EP 335 214 A (U.S. Pat. Nos. 4,977,233 and 5,091,482, its indicated equivalents are incorporated herein by reference) and DE 3 007 934 A. Monophenols as well as monocarboxylic acids may be mentioned by way of example, but not exclusively, as suitable chain terminators. Suitable monophenols are phenol, alkylphenols such as cresols, p-tert.-butylphenol, p-n-octylphenol, p-iso-octylphenol, p-n-nonylphenol and p-iso-nonylphenol, halogenated phenols such as p-chlorophenol, 2,4-dichlorophenol, p-bromophenol and 2,4,6-tribromophenol, and/or their mixtures.

Preferred are p-tert.-butylphenol or phenol, the latter being particularly preferred.

Suitable monocarboxylic acids are benzoic acid, alkylbenzoic acids and halogenated benzoic acids.

Diols, from which T is derived, include for example:

1,7-heptanediol, 1,8-octanediol, 1,6-hexanediol, 1,5-pentanediol, 1,4-butanediol, 1,3-propanediol, 2-methyl-1,3-propanediol, 3-methyl-1,5-pentanediol, 2-methylpentanediol, 2,2,4-trimethyl-1,6-hexanediol, 2,3,5-trimethyl-1,6-hexanediol, cyclohexane-dimethanol, neopentyl glycol, dodecanediol, perhydro-bisphenol A, spiro-undecane diols, ethoxylated or propoxylated bisphenols with aliphatic polyether polyols of different chain lengths as terminal groups, such as for example Dianole®, Newpole® and ethoxylated BP-TMC, ethoxylated or propoxylated resorcinols, hydroquinones, pyrocatechols with aliphatic polyether polyols of different chain lengths as terminal groups, polypropylene glycol, polybutylene glycol as well as polyether polyols that have been obtained by copolymerisation of for example ethylene oxide and propylene oxide, dihexyl, trihexyl and tetrahexyl ether glycol, etc., as well as mixtures of various diols.

There may, furthermore, be included addition products of the diols with lactones (ester diols) such as for example caprolactone, valerolactone, etc., as well as mixtures of the diols with lactones, an initial transesterification of lactones and diols not being necessary.

There may also be included addition products of diols with dicarboxylic acids such as for example adipic acid, glutaric acid, succinic acid, malonic acid, hydroxypivalic acid, etc., or esters of the dicarboxylic acids as well as mixtures of diols with dicarboxylic acids and/or esters of the dicarboxylic acids, in which connection an initial transesterification of dicarboxylic acid and the diols is not necessary but is possible. Poly(neopentyl glycol adipate) and hydroxypivalic acid neopentyl glycol ester may be mentioned by way of example.

The synthesis of such aliphatic polycarbonates is described in detail in US 2003/0204042 the content of which is incorporated herein by reference.

In a further embodiment of the invention component B is a low molecular weight aliphatic carbonate, having a mean molecular weight M_{w} of 260 to 20,000, preferably 300 to 7,300, an particularly preferably from 350 to 3,000, and comprising a repeating unit of the formula (VI),

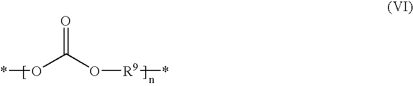

where R⁹ is derived from aliphatic diols containing between 3 and 50 carbon atoms in the chain, preferably between 4 and 40 carbon atoms and more preferably between 4 and 20 carbon atoms. 1,6-hexanediol is particularly preferred.

The diols may additionally contain ester, ether, amide and/or nitrile functions. Diols or diols with ester functions, such as are obtained for example by using caprolactone and 1,6-hexanediol, and also diols with ether functions, are preferably used. If two or more diol components are used (for example mixtures of various diols or mixtures of diols with lactones), then two adjacent R⁹ groups in a molecule may be completely different (random distribution).

The synthesis of these low molecular weight aliphatic polycarbonates is also disclosed in US 2003/0204042 mentioned above.

Preferably, component (B) is an aromatic polycarbonate.

### Component (C):

Suitable inorganic boron containing compounds are preferably ortho- and meta-boric acid, H₃BO₃, ammonium borate, ammonium boron oxide (NH₄)₂B₄O₇ and (NH₄)B₅O₈ and boron oxide B₂O₃. Most preferred are ortho and meta boric acid, H₃BO₃.

### Component (D):

Optionally, the thermoplastic molding compositions according to the invention may contain small proportions of further polymer resins, preferably below 25 wt. %, particularly preferably below 10 wt. %. Examples of further polymer resins are aromatic polyesters, for example polyethylene terephthalate or polybutylene terephthalate, thermoplastic polyurethanes, polyacrylates, for example copolymers of (meth)acrylate monomers with acrylonitrile or polyacetals, for example polyoxymethylene, together with polyamides such as, for example, polyamide-6 or polyamide-66.

### Component (E):

In addition to the basic additives already mentioned above, component (E) includes lubricants or mold-release agents, waxes, pigments, dyes, flame retardants, antioxidants, stabilizers to counter the action of light, fibrous and pulverulent fillers, fibrous and pulverulent reinforcing agents, antistats and other additives, or mixtures of these.

Representative examples of the lubricants include metal soap, such as calcium stearate, magnesium stearate, zinc stearate, and lithium stearate, ethylene-bis-stearamide, methylene-bis-stearamide, palmityl amide, butyl stearate, palmityl stearate, polyglycerol tristearate, n-docosanoic acid, stearic acid, polyethylene-polypropylene wax, octacosanoic acid wax, Carnauba wax, montan waxes and petroleum wax. The amount of the lubricants is generally 0.03 to 5.0 wt %, based on the total amount of the rubber-modified styrenic resin composition.

Examples of pigments are titanium dioxide, phthalocyanines, ultramarine blue, iron oxides and carbon black, and the entire class of organic pigments.

For the purposes of the invention, dyes are all dyes which can be used for the trans-parent, semitransparent or non-transparent coloration of polymers, in particular those which are suitable for coloration of styrene copolymers. Dyes of this type are known to the person skilled in the art.

Representative examples of the flame retardant or its synergistic additives include decabromo-diphenyl ether, tetrabromo-bisphenol A, brominated-polystyrene oligomer, bromoepoxy resin, hexabromocyclododecane, chloropolyethylene, triphenyl phosphate, red phosphorous, antimony oxide, aluminium hydroxide, magnesium hydroxide, zinc borate, melamine-isocyanate, phenol resin, silicone resin, polytetrafluoroethylene and expanding graphite.

Particularly suitable antioxidants are sterically hindered mono- or polynuclear phenolic antioxidants, which may be substituted in various ways and also bridged via substituents. These include not only monomeric but also oligomeric compounds, which may be built up from more than one fundamental phenol unit. Hydroquinones and substituted compounds which are hydroquinone analogs are also suitable, as are antioxidants based on tocopherols and their derivatives. Mixtures of different antioxidants may also be used. Examples of the antioxidants are phenolic antioxidants, thio-ether antioxidants, phosphorous-based antioxidants and chelating agents. The phenolic antioxidants are preferably added in an amount of 0.005 to 2.0 wt %. Representative examples of the phenolic antioxidants include octadecyl (3,5-di-tert-butyl-4-hydroxyphenyl) propionate, tri-ethylene glycol-bis-3-(3-tert-butyl-5-methyl-4-hydroxyphenyl)propionate, pentaerythritol-tetrakis-3-(3,5-di-tert-butyl-4-hydroxyphenyl)propionate, 2-tert-butyl-6-(3-tert-butyl-2-hydroxy-6-methylbenzyl)-4-methy phenyl acrylate, 2,2′-methylene-bis-(4-methyl-6-tert-butyl phenol), butylated reaction product of p-cresol and dicyclopentadiene, 2,2′-thio-bis-(4-methyl-6-tert-butyl phenol), 2,2′-thio-diethylene-bis[3(3,5-di-tert-butyl-4-hydroxy-phenyl)propionate], and 2,2′-ethylene diamide-bis[ethyl-3-(3,5-di-tert-butyl-4-hydroxy-phenyl)propionate].

In principle, it is possible to use any compound which is commercially available or suitable for styrene copolymers, such as Topanol® (Rutherford Chemicals, Bayonne, N.J., USA), Irganox® (Ciba Specialty Chemicals, Basel, Switzerland) or Wingstay® (Eliokem, Villejust, France).

Alongside the phenolic antioxidants mentioned as examples above, it is possible to use co stabilizers, in particular phosphorus- or sulphur-containing co stabilizers.

The thio-ether antioxidants are preferably added in an amount of 0.005 to 2.0 wt %. The phosphorous-based antioxidants include phosphite, phosphate, phosphonite and phosphonate antioxidants. The phosphorous-based antioxidants are preferably added in an amount of 0.015 to 2.0 wt %. Representative examples of the phosphorous anti-oxidants are tris(nonylphenyl)phosphite, tris(2,4-di-t-butylphenyl)phosphite, triisodecyl phosphite, distearyl pentaerythritol di-phosphite, triphenyl phosphite, diphenyl isodecyl phosphite, tris(isotridecyl)phosphite, tetraphenyl dipropylene glycol, diphosphite, distearyl hydrogen phosphite, diphenyl phenyl phosphonate, tetrakis (2,4-di-tert-butyl phenyl)-4,4′-biphenylene di phosphonite.

Representative examples of the thio-ether antioxidants include distearyl thio-dipropionate, dipalmitoyl thio-dipropionate, dilauryl thio-dipropionate, pentaerythritol-tetrakis-(β-dodecyl methyl-thiopropionate) and dioctadecyl thioether.

Such phosphorus- or sulphur-containing co stabilizers are known to the person skilled in the art and are commercially available.

Representative examples of the heat stabilizer include dibutyl tin maleate and basic magnesium aluminium hydroxy carbonate. A low molecular styrene-maleic anhydride copolymer can also serve as a hear stabilizer to prevent thermal discoloring. The amount of the heat stabilizer is in generally 0.1 to 1.0 wt %, based on the total amount of the rubber modified styrenic resin composition.

Examples of suitable stabilizers to counter the action of light are various substituted resorcinols, salicylates, benzotriazoles, benzophenones and HALS (hindered amine light stabilizers), commercially available, for example, as Tinuvin® (Ciba Specialty Chemicals, Basel, Switzerland). The amount of the preceding additives is generally 0.02 to 2.0 wt % based on the total amount of the rubber-modified styrenic resin composition.

Examples of fibrous and/or particulate fillers are carbon fibers or glass fibers in the form of glass fabrics, glass mats or glass fiber rovings, chopped glass or glass beads, and wollastonite, particularly preferably glass fibers. If glass fibers are used, these may be provided with a size and a coupling agent for better compatibility with the blend components. The glass fibers may be incorporated either in the form of short glass fibers or in the form of continuous strands (rovings).

Suitable particulate fillers are carbon black, amorphous silicic acid, magnesium carbonate, chalk, powdered quartz, mica, bentonites, talc, feldspar or in particular calcium silicates, such as wollastonite, and kaolin.

Chelating agents can preferably be added in an amount of 0.001 to 2.0 wt %. Representative examples of the chelating agent include 2,2′-oxamido-bis-[ethyl 3-(3,5-di-tert-butyl-4-hydroxyphenyl)propionate], the sodium salt of ethylene diamine tetra acetic acid, amino tri(methylene phosphonic acid), 1-hydroxy ethylidene(1,1-diphosphonic acid), ethylene diamine tetra(methylene phosphonic acid), hexamethylene diamine tetra(methylene phosphonic acid) and diethylene triamine penta(methylene phosphonic acid).

A processing aid, such as methyl methacrylate-based copolymer, may be added to improve the extrusion and thermoforming. In addition, silicone oils, oligomeric isobutylene or similar materials are suitable for use as additives. If used, the usual concentrations thereof are from 0.001 to 5 wt. %.

The molding composition (F) can be produced by known processes:

Mixing of the polymer components to produce the thermoplastic molding compositions (F) according to the invention may proceed in customary mixing units, thus, for example, in kneaders, internal mixers, in roll mills, screw compounders or extruders, preferably above 200° C. The constituents may be blended consecutively or simultaneously. Preferably, components (A), (B) and (C) and optionally (D) and/or (E) are mixed simultaneously.

Details concerning the preparation of the thermoplastic molding composition (F) are as follows.

The graft polymers having bimodal particle size distribution are preferably prepared by emulsion polymerization, as described above for component (A1). As described above, suitable measures are taken in order to establish the bimodal particle size distribution, preference being given to (partially) agglomerating the polymer particles, as mentioned, by adding a polyacrylate dispersion which has agglomerating effect. Instead of this, or combined with the (partial) agglomeration, it is possible to use other suitable measures familiar to the person skilled in the art to establish the bimodal particle size distribution. The resultant dispersion of the graft polymer (A) is preferably worked up prior to the mixing with components (A2) to (E).

The dispersion of component (A1) is generally worked up in a manner known per se. E.g., component (A1) is firstly precipitated from the dispersion, for example by adding acids (such as acetic acid, hydrochloric acid or sulphuric acid) or salt solutions (such as calcium chloride, magnesium sulphate or alum) which can bring about precipitation, or else by freezing (freeze coagulation). The aqueous phase may be removed in a usual manner, for example by screening, filtering, decanting or centrifuging. This preliminary removal of the dispersion water gives polymers (A1) which are moist with water and have a residual water content of up to 60 wt. %, based on (A1), where the residual water may, for example, either adhere externally to the polymer or else be enclosed within it.

After this, the polymer may, if required, be dried in a known manner, for example by hot air or using a pneumatic dryer. It is likewise possible to work up the dispersion by spray drying.

Preferably component (A1) is then mixed with components (A2) and (C) before further mixing with components (B), (D) and (E).

The thermoplastic molding composition (F) is produced according to methods well known to those skilled in the art.

Mixing can be carried out by any known method and in any desired manner.

Preferably mixing is carried out in a mixing apparatus.

If one or more components are incorporated in the form of an aqueous dispersion or of an aqueous or non-aqueous solution, the water or the solvent is removed from the mixing apparatus, preferably an extruder, via a devolatilizing unit.

Examples of mixing apparatuses are discontinuously operating heated internal mixers with or without rams, continuously operating kneaders, such as continuous internal mixers, screw compounders having axially oscillating screws, Banbury mixers, and also extruders, roll mills, mixing rolls where the rolls are heated and calenders.

Preference is given to using an extruder as mixing apparatus. Single- or twin-screw extruders, for example, are particularly suitable for extruding the melt. A twin-screw extruder is preferred.

Blending of the components is preferably carried out by co extruding, kneading or roll-milling the components at temperatures of, preferably, from 180 to 400° C.

The invention also therefore provides a process for the production of the molding compounds according to the invention by blending the constituents at elevated temperature.

The molding compositions (F) can be processed to shaped articles, including films or fibers.

According to one embodiment of the invention, these can be prepared from molding compositions (F), by known methods of processing thermoplastics. In particular, production may be effected by thermoforming, extruding, injection molding, calendaring, blow molding, pressing, pressure sintering, deep drawing or sintering, preferably by injection molding.

Examples of such moldings are casing parts, covering plates or automotive parts. Moldings may also be produced by thermoforming previously produced sheets or films. The invention also therefore provides the use of the described molding compositions for the production of moldings.

The invention is illustrated by the following examples without limiting it thereby.

### EXAMPLES

### 1. Preparation of the Graft Polymer (A1)

1.1 Preparation of the Graft Base (a1)

Emulsion polymerizations were carried out in a 150 liter reactor at a constant temperature of 67° C. 43,120 g of the monomer mixture given in Table 1 were polymerized at 67° C. in the presence of variable amounts of tert-dodecyl mercaptane (TDM), 311 g of the potassium salt of C.12.12-C.20 fatty acids, 82 g of potassium persulfate, 147 g of sodium hydrogen carbonate and 58400 g of water, to give a polybutadiene latex. First 10 wt. % styrene was added within 20 minutes. After the styrene addition, the first part of the butadiene, which corresponds to 10 wt. % of the total amount of monomer in the recipe, was added in 25 minutes. The remaining part of the butadiene, was added in 8.5 hours. The TDM being added in one portion at the start of the reaction. The conversion was 95% or greater.

The dispersion had a d₅₀ of 90 nm. The swelling index was 23 and the gel content 85%.

To agglomerate the latex, 5265 g of the resultant latex, diluted to a TSC of 40%, is agglomerated (partial agglomeration) at 68° C. by adding 526.5 g of a dispersion (solids content 10 wt. %) of 96 wt. % of ethyl acrylate and 4 wt. % of methacrylamide.

### 1.2 Preparation of the Graft Polymer (A1)

Following agglomeration, 20 g emulsifier (potassiumstearate) and 3 g initiator (potassium persulfate) were added. Water was added in an amount to set the total solid content of the dispersion after completion of the polymerization to a theoretical value of 40%. 74.7 g of acrylonitrile, 298.8 g of styrene were then added. A mixture of 224.1 g of acrylonitrile, 896.4 g of styrene was then added over a period of 190 minutes, the temperature being raised to 77° C. after half of the time. On completion of the addition of monomer, 3 g initiator (potassium persulfate) was again added and the polymerization was continued for 60 minutes.

The resultant graft polymer dispersion, which had bimodal particle size distribution, had a mean particle size d₅₀ from 150 to 350 nm and a d₉₀ of from 400 to 600 nm. The particle size distribution had a first maximum in the range from 50 to 150 nm and a second maximum in the range from 200 to 600 nm.

To the dispersion there were added 0.2 wt. % of a stabilizer, based, in each case, on the total solids content, and the mixture was cooled and coagulated at ca. 60° C. in an aqueous 0.5% MgSO4-solution followed by an aging step for 10 minutes at 100° C. The pH value of the slurry after coagulation was 8.2. Afterwards the slurry was cooled down, centrifuged and washed with water to obtain a graft polymer (A1) with a moisture content of about 30%.

### 2. Preparation of the Thermoplastic Component (A2)

The thermoplastic polymers, a copolymer from styrene and acrylonitrile were prepared by continuous solution polymerization, as described in Kunststoff-Handbuch, ed. R. Vieweg and G. Daumiller, Vol, V “Polystyrol”, Carl-Hanser-Verlag, Munich, 1969, p. 122-124. Formulations and properties are given in table 1:

TABLE 1

Component

| Monomers [wt. %] | A2₁ | A2₂ |
|---|---|---|
| Styrene | 76 | 75 |
| Acrylonitrile | 24 | 25 |
| Viscosity number | 64 | 80 |
| VN [ml/g] | | |

### 3. Preparation of the ABS Type Resin

The graft rubber (A1) containing residual water was metered into a Werner and Pfleiderer ZSK 30 extruder in which the front part of the two conveying screws were provided with retarding elements which build up pressure. A considerable part of the residual water was pressed out mechanically in this way and left the extruder in liquid form through water-removal orifices. The other components (A2) and (E) were added to the extruder downstream behind the restricted flow zones, and intimately mixed with the dewatered component (A1). The residual water still present was removed as steam by venting orifices in the rear part of the extruder. The extruder was operated at 250° C. and 250 rpm, with a throughput of 10 kg/h. The molding composition was extruded and the molten polymer mixture was subjected to rapid cooling by being passed into a water bath at 25° C. The hardened molding composition was granulated.

Two ABS type resins were prepared. The components used and their constituent amounts are given in table 2:

TABLE 2

ABS Resin

| | 1 | 2 |
|---|---|---|
| Amount Graft A1 | 40 | 38 |
| (wt. % dry) | | |
| A2 | A2₁ | A2₂ |
| Amount A2 (wt. %) | 60 | 62 |
| E* (wt. %) | 0.8 | |
| E** (wt. %) | | 0.225 |

E* mixture of 0.1 weight parts Wingstay L, 0.1 weight parts PS 800, 0.1% weight parts silicon oil and 0.5 weight parts Pluronic 8100.
E** mixture of 0.1 weight parts Wingstay L, 0.1 weight parts PS 800, and 0.025 weight parts silicon oil.

Wingstay L=butylated condensation products of para cresol and dicyclopentadiene (Goodyear)
PS8100=dilauryl-dithiopropionate (Ciba Geigy)
Pluronic 8100=ethylene oxide-propylene oxide block copolymer (BASF)

### Production and Testing of the Molding Compositions

Molding compositions were produced by mixing the parts by weight stated in table 3 of the above-described components in an ZSK-30 extruder at approx. 240° C. The throughput was 10 kg/h and the number of revolutions was 250 turns/minute. Afterwards the compounds were injection molded into test-pieces at 250° C.

### Measurements Carried Out:

### Swell Index and Gel Content [%]

A film was prepared from the aqueous dispersion of the graft base by evaporating the water. To 0.2 g of this film there were added 50 g of toluene. After a period of 24 hours the toluene was removed from the swollen sample by filtration with suction and the sample was weighed. After drying in vacuum at 110° C. over a period of 16 hours, the sample was reweighed. The swelling index is the ratio of the specimen weight after the swelling procedure to the dry specimen weight after the second drying. The gel content is calculated correspondingly from the ratio of the dry weight after the swelling step to the weight of the specimen before the swelling step (×100%).

### Particle Sizes of the Rubber Latex

The mean particle size d stated is the weight average of the particle size, as determined with an analytical ultracentrifuge following the method of W. Machtle, S. Harding (Eds.), AUC in Biochemistry and Polymer Science, Royal Society of Chemistry Cambridge, UK 1992 pp. 1447-1475. The ultracentrifuge readings give the integral mass distribution of the particle diameter in a sample. This makes it possible to determine what percentage by weight of the particles has a diameter equal to or smaller than a specific size.

The weight-average particle diameter d 50 indicates the particle diameter at which 50 wt. % of all particles have a larger particle diameter and 50 wt. % have a smaller particle diameter.

### Viscosity Number (VN)

The VN is determined according to DIN 53726 on a 0.5% strength by weight solution of the polymer in dimethylformamide.

Flowability (MVR [ml/10′])

Tests were carried out according to ISO 1133 B on the polymer melt at 220° C. under a load of 10 kg

Charpy Impact Strength (aₖ[kJ/m².])

Tests were carried out on specimens (80×, 10×, 4 mm, prepared according to ISO 294 in a family mold at a mass temperature of 250° C. and a mold temperature of 60° C.) at 23° C. according to ISO 179-2/leA (F).

### Elasticity (Modulus of Elasticity [MPa])

Tests were carried out according to ISO 527-2/1A/50 on specimens (prepared according to ISO 294 at a mass temperature of 250° C. and a mold temperature of 60° C.).

### Vicat [° C.]

The Vicat softening point was determined on small pressed sheets according to ISO 306/B using a load of 50 N and a heating rate of 50 K/h.

### Yellowness Index YI

The Yellowness-index YI was determined by determining the color coordinates X, Y, Z according to DIN 5033 using standard illuminant D 65 and a 10.H°. standard observer, and the following defining equation:

YI=(131.48X−116.46Z)/Y

TABLE 3

| | Example/Comparative Example (C) | | | | | | | |
|---|---|---|---|---|---|---|---|---|
| | C1 | 1 | C2 | C3 | C4 | 2 | 3 | C5 |
| Polycarbonate | 60 | 60 | 60 | 60 | 60 | 60 | 60 | 60 |
| (Lexan 161) | | | | | | | | |
| ABS 1 | 40 | 40 | 40 | 40 | — | — | — | — |
| ABS 2 | — | — | — | — | 40 | 40 | 40 | 40 |
| Boric acid | — | 0.02 | — | — | — | 0.01 | 0.03 | — |
| p-Toluenesulphonic | — | — | 0.1 | — | — | — | — | — |
| acid | | | | | | | | |
| Citric acid | — | — | — | 0.1 | — | — | — | 0.1 |

Lexan 161 = GEP aromatic polycarbonate with a viscosity number of 61.3 microliter/g (0.5 wt %) in CH₂Cl₂ at 23° C.

### Properties

| | Example/Comparative Example (C) | | | | | | | |
|---|---|---|---|---|---|---|---|---|
| | C1 | 1 | C2 | C3 | C4 | 2 | 3 | C5 |
| Flowability | 4.4 | 3.9 | 3.5 | 3.4 | 8.0 | 6.8 | 6.8 | 6.4 |
| MVR [ml/10′] | | | | | | | | |
| Charpy Impact Strength | 48 | 51 | 52 | 53 | 57 | 64 | 63 | 55 |
| ak [kJ/m2] | | | | | | | | |
| Modulus | 2200 | 2220 | 2200 | 2210 | 2330 | 2330 | 2330 | 2330 |
| of Elasticity [MPa] | | | | | | | | |
| Vicat B [° C.] | 123 | 122 | 123 | 123 | 120 | 119 | 118 | 117 |
| Yellowness Index | 11 | 11 | 24 | 22 | 8 | 7 | 8 | 16 |

As may be seen from the examples, in comparison with the comparative examples without component C, the molding compositions according to the invention exhibit distinctly better properties, in particular a combination of high strength and low yellowness index after processing with equally good heat resistance (Vicat B) and modulus of elasticity. Furthermore it can be concluded from the MVR values that the thermal stability of the blends is remarkably improved with only minor amounts of component C, although the ABS resin contains basic additives.

1. A thermoplastic molding composition (F) comprising
(A) 10 to 50 wt. % of a rubber modified styrenic resin;
(B) 50 to 90 wt. % of a polycarbonate resin;
(C) 0.005 to 0.1 wt % of an inorganic boron compound;
(D) 0 to 25 wt. % of further polymer resins; and
(E) 0 to 45 wt. % additives.

2. The thermoplastic molding composition as claimed in claim 1 comprising a basic component.

3. The thermoplastic molding composition as claimed in claim 2, where the basic component was formed in the work up of the rubber modified styrenic resin (A).

4. The thermoplastic molding composition as claimed in claim 1, where the inorganic boron compound is selected from orthoboric acid, meta-boric acid, ammonium borate, ammonium boron oxide and boron oxide.

5. The thermoplastic molding composition as claimed in claim 4, where the inorganic boron compound is ortho-boric acid, meta-boric acid or boron oxide.

6. The thermoplastic molding composition as claimed in claim 1 where the rubber modified styrenic resin (A) comprises 5 to 100 wt. % of a graft polymer (A1) and 95 to 0 wt. % of a thermoplastic copolymer resin (A2).

7. The thermoplastic molding composition as claimed in claim 6, where the graft polymer (A1) is built from a particulate (a1) graft base, obtained by polymerizing, based on (a1),
a11) from 70 to 100 wt. %, of one conjugated diene, or of at least one C₁₋₈-alkyl acrylate, or of mixtures of these,
a12) from 0 to 30 wt. %, of at least one other monoethylenically unsaturated monomer, and
a2) a graft, obtained by polymerizing, based on (a2),
a21) from 65 to 95 wt. %, of at least one vinylaromatic monomer,
a22) from 5 to 35 wt. %, of acrylonitrile,
a23) from 0 to 30 wt. %, of at least one further monoethylenically unsaturated monomer, and
a24) from 0 to 10%, of at least one polyfunctional, cross linking monomer.

8. The thermoplastic molding composition as claimed in claim 1, where the polycarbonate resin comprises an aromatic polycarbonate.

9-11. (canceled)

12. The thermoplastic molding composition as claimed in claim 2, where the inorganic boron compound is selected from ortho-boric acid, meta-boric acid, ammonium borate, ammonium boron oxide and boron oxide.

13. The thermoplastic molding composition as claimed in claim 12, where the inorganic boron compound is ortho-boric acid, meta-boric acid or boron oxide.

14. The thermoplastic molding composition as claimed in claim 2, where the rubber modified styrenic resin (A) comprises 5 to 100 wt. % of a graft polymer (A1) and 95 to 0 wt. % of a thermoplastic copolymer resin (A2).

15. The thermoplastic molding composition as claimed in claim 14, where the graft polymer (A1) is built from a particulate (a1) graft base, obtained by polymerizing, based on (a1),
a11) from 70 to 100 wt. %, of one conjugated diene, or of at least one C₁₋₈-alkyl acrylate, or of mixtures of these,
a12) from 0 to 30 wt. %, of at least one other monoethylenically unsaturated monomer, and
a2) a graft, obtained by polymerizing, based on (a2),
a21) from 65 to 95 wt. %, of at least one vinylaromatic monomer,
a22) from 5 to 35 wt. %, of acrylonitrile,
a23) from 0 to 30 wt. %, of at least one further monoethylenically unsaturated monomer, and
a24) from 0 to 10% wt. %, of at least one polyfunctional, cross linking monomer.

16. The thermoplastic molding composition as claimed in claim 2, where the polycarbonate resin comprises an aromatic polycarbonate.

17. A process for producing a thermoplastic molding composition according to claim 1, where
(A) 10 to 50 wt. % of a rubber modified styrenic resin;
(B) 50 to 90 wt. % of a polycarbonate resin;
(C) 0.005 to 0.1 wt. % of an inorganic boron compound;
(D) 0 to 25 wt. % of further polymer resins; and
(E) 0 to 45 wt. % additives
are blended at elevated temperatures.

18. A process for producing a thermoplastic molding composition according to claim 2, where
(A) 10 to 50 wt. % of a rubber modified styrenic resin;
(F) 50 to 90 wt. % of a polycarbonate resin;
(G) 0.005 to 0.1 wt. % of an inorganic boron compound;
(H) 0 to 25 wt. % of further polymer resins; and
(I) 0 to 45 wt. % additives
are blended at elevated temperatures.

19. A mold produced from the thermoplastic molding composition according to claim 1.

20. A mold produced from the thermoplastic molding composition according to claim 2.

21. The thermoplastic molding composition as claimed in claim 3, where the rubber modified styrenic resin (A) comprises 5 to 100 wt. % of a graft polymer (A1) and 95 to 0 wt. % of a thermoplastic copolymer resin (A2).

22. The thermoplastic molding composition as claimed in claim 21, where the graft polymer (A1) is built from a particulate (a1) graft base, obtained by polymerizing, based on (a1),
a11) from 70 to 100 wt. %, of one conjugated diene, or of at least one C₁₋₈-alkyl acrylate, or of mixtures of these,
a12) from 0 to 30 wt. %, of at least one other monoethylenically unsaturated monomer, and
a2) a graft, obtained by polymerizing, based on (a2),
a21) from 65 to 95 wt. %, of at least one vinylaromatic monomer,
a22) from 5 to 35 wt. %, of acrylonitrile,
a23) from 0 to 30 wt. %, of at least one further monoethylenically unsaturated monomer, and
a24) from 0 to 10% wt. %, of at least one polyfunctional, cross linking monomer.

23. The thermoplastic molding composition as claimed in claim 3, where the polycarbonate resin comprises an aromatic polycarbonate.
